(19) United States
(12) Patent Application Publication
(10) Pub. No.: US 2019/0254459 A1
(43) Pub. Date: Aug. 22, 2019

(54) PACKAGE RECEPTACLE SYSTEM AND METHOD

(71) Applicant: Gregory Hengst, Bay Village, OH (US)

(72) Inventor: Gregory Hengst, Bay Village, OH (US)

(21) Appl. No.: 16/280,937

(22) Filed: Feb. 20, 2019

Related U.S. Application Data
(60) Provisional application No. 62/632,881, filed on Feb. 20, 2018.

(51) Int. Cl. A47G 29/14; G06Q 50/32; G07F 5/26; A47G 29/12

(52) U.S. Cl. CPC A47G 29/141; G06Q 50/32; G07F 17/12; A47G 29/1207; G07F 5/26

(57) ABSTRACT

A package receptacle system; the package receptacle system includes a box comprising a substantially cubic-volume. The box includes a front-door and an opposed rear-door configured to provide access to the substantially cubic-volume when in an open state. The front-door and the rear-door include a front-locking mechanism and a rear-locking mechanism, respectively. A display is disposed on the box for displaying symbolic information by emitting linearly polarized light. A controller is integrated to the package receptacle system. The controller is in communication with the front-locking mechanism, the rear-locking mechanism, and the display. The display is configured to receive an external signal that actuates the front-door into a front-open state. In a preferred embodiment of operation, through predefined programming, the package receptacle system will allow parcels to be stowed safely by a courier.

### CROSS-REFERENCE TO RELATED APPLICATION(S)

The present application is related to and claims priority to U.S. Provisional Patent Application No. 62/632,881 filed Feb. 20, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of receptacles of existing art and more specifically relates to mail receptacles.

### RELATED ART

Courier services such as the United States Post Office deliver packages sent through the mail to nearly every address in the modern world. Patrons of the various couriers include all residential and commercial buildings that are registered for delivery services. A building will generally employ a mail parcel receiving structure such as a mailbox. In many instances the designated parcel receiving structure is unlocked, allowing for parcels to be easily delivered and recovered.

Online shopping allows for anyone with an internet connection and a delivery address to procure a greater number of items than could otherwise be procured locally. Ordering items from the internet has increased in volume along with packages ordered from online sources. Customers are drawn to online procurement due to high availability and low prices. Other, more customized, items can only be purchased through online vendors. Popular customized items include electronic devices such as computers and other various advanced technologies. These items fetch a high price tag and are therefore high value targets for thieves. Packages procured through internet sources may also be too large to place in a standard mailbox. The packages are then delivered to the location by leaving the oversized package in a visible location for the recipient. Various attempts have been made to protect delivered packages by employing locks and other security measures. A reliable solution is desired.

U.S. Pat. No. 5,921,117 to Frank J. Illguth relates to a mailbox locking device. The described mailbox locking device includes a locking receptacle and a locking device for securing a mailbox, package delivery box, or other receptacle requiring a single opening of the receptacle door for a mailperson or package delivery person to insert a package being delivered and upon subsequent closing of the door locking until unlocked by a person having a key or combination therefor to receive the delivery. The locking device mounts to the inside of the receptacle and has an arm which is pivotally attached to the door of the receptacle and to a reciprocally pivotal locking disk. A first pivoting lever is positioned to engage a slot in the periphery of the locking disk when the door is closed so as to restrain the locking disk and the door in a closed position. A spring-biased, reciprocally pivotal counting disk is arranged to turn with the locking disk as the door is opened and to lock in that position by means of a second pivoting lever which engages a slot in the periphery of the counting disk. The first and second levers are interconnected such that the first lever will engage the slot in the locking disk when the door is closed only when the second lever is engaged in the slot in the counting disk. A key or combination type lock has a movable reset arm which when in the unlocked position contacts both levers to remove them from engagement with their respective slots to reset the locking device and upon moving to the locked position arms the locking device for subsequent single opening and closing operation of the receptacle door. Versions having linear acting locking and counting members are disclosed which operate similarly.

### SUMMARY OF THE INVENTION

In view of the foregoing disadvantages inherent in the known mail receptacle art, the present disclosure provides a novel package receptacle system and method. The general purpose of the present disclosure, which will be described subsequently in greater detail, is to provide an efficient and effective package receptacle system and method.

A package receptacle system is disclosed herein. The package receptacle system includes a box comprising a substantially cubic-volume. The box includes a front-door that is configured to provide access to the substantially cubic-volume when in a front-open state. The box further includes a rear-door disposed on an end of the box from the front-door. The rear-door is also configured to provide access to the substantially cubic-volume when in a rear-open state. The front-door and the rear-door include a front-locking mechanism and a rear-locking mechanism, respectively. A display is disposed on the box for displaying symbolic information by emitting linearly polarized light. A controller is integrated to the package receptacle system for communicating between components. The controller is in communication with the front-locking mechanism, the rear-locking mechanism, and the display. The display is configured to receive an external signal that actuates the front-door into a front-open state. In a preferred embodiment of operation, through predefined programming, the package receptacle system will allow parcels to be stowed safely by an authorized courier.

According to another embodiment, a method of using a package receptacle is also disclosed herein. The method of using a package receptacle includes a providing a package receptacle system as described above; installing a package receptacle system to a building; registering access functionality to the package receptacle. A step of, opening a package receptacle system with biometric input is also considered.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a package receptacle system and method, constructed and operative according to the teachings of the present disclosure.

FIG. 1 is a front view of the package receptacle during an ‘in-use’ condition, according to an embodiment of the disclosure.

FIG. 2 is a rear view of the package receptacle of FIG. 1, according to an embodiment of the present disclosure.

FIG. 3 is a front perspective view of the package receptacle of FIG. 1, according to an embodiment of the present disclosure.

FIG. 4 is a front perspective view of the package receptacle of FIG. 1, according to an embodiment of the present disclosure.

FIG. 5 is a flow diagram illustrating a method of using a package receptacle system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a mail receptacle and more particularly to a package receptacle system and method as used to improve the reliability of package delivery.

Generally, the package receptacle system is a mailbox having a volume that may be accessed from both inside and/or alternately outside of a building. The package receptacle system may be integrated into an existing building through a wall. The system includes a front door that is accessible from outside, and a rear door that is accessible from the inside of a building. A display screen is disposed on the front door that receives predefined input from authorized persons. The predefined input may then open the front door and grant access to the interior volume, allowing a package to be placed. The input given to the system may vary according by programming. In some embodiments the input may be biometric and configured to recognize specific characteristics of the person requesting access. Common characteristics include fingerprints, irises, palm scans, face recognition, and further conceived biometrics. In other embodiments the input given may be from a registered signal generator such as a laser scanner commonly used to read barcodes. In yet other embodiments, a combination may be programmed using alphanumeric characters, symbols, and patterns. The rear door may include similar accessibility functions. Both the front and the rear door may include keys to manually override to the locking mechanism.

The package receptacle system may be added to existing buildings through the use of any variety of supporting flanges. The flanges make a connection to the wall to statically secure the package receptacle in a desired location. However, alternate means of anchoring the package receptacle may be utilized. In some instances, pillars, molds, steel retaining structures, and conceptual designs based at the planning stages of a building may be optimal choices. The system may be configured to draw electricity from the main electricity of a location, the conventional domestic power source.

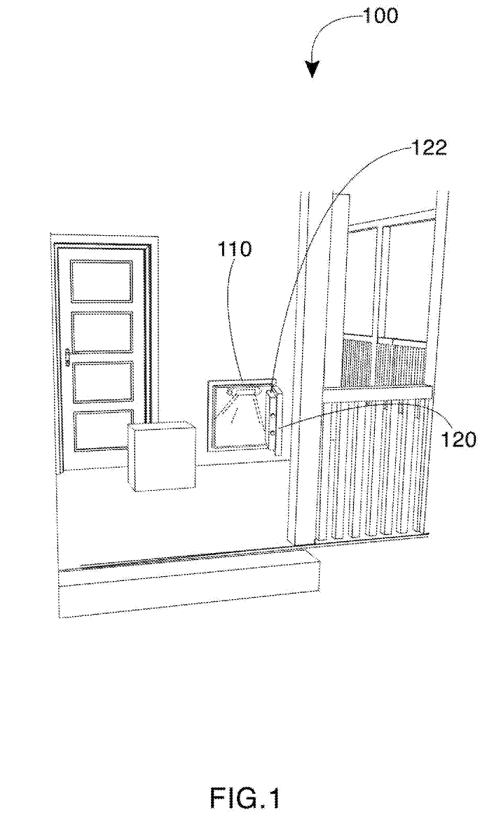

Referring now more specifically to the drawings by numerals of reference, there is shown in FIGS. 1-4, various views of a package receptacle 100.

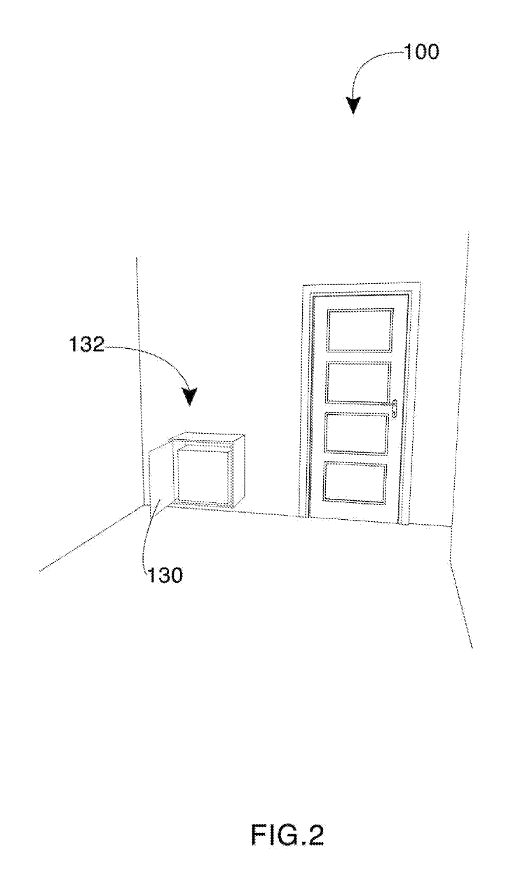

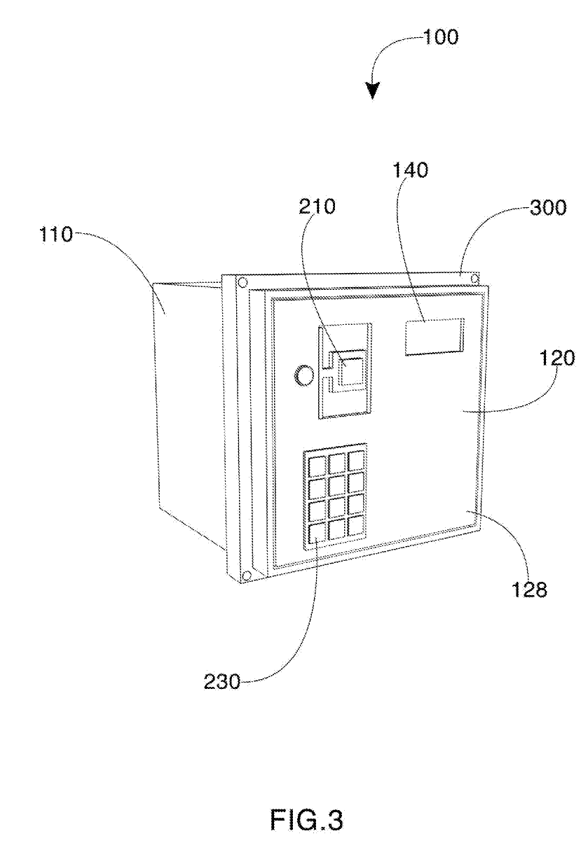

FIG. 1 shows a package receptacle 100 according to an embodiment of the present disclosure. Here, the package receptacle 100 may be beneficial to allow for the delivery and stowage of packages. As illustrated, the package receptacle 100 may comprise a box 110 having a front-door 120 configured to provide access to the substantially cubic-volume when in a front-open state 122. The front-door 120 includes a front-locking mechanism (not shown). The front-locking mechanism (not shown) may be opened by a set access feature known to trusted parties. The front-locking mechanism is configured to retain the front-door 122 in a front-closed state 128 (FIG. 3). Typically, a delivery will be expected, and arrangements will be made in advance to grant the courier access. A rear-door 130 (FIG. 2) is disposed on an opposed end of the box 110 from the front-door 120. The rear-door 130 is configured to provide access to the substantially cubic-volume when in a rear-open state 132 (FIG. 2). The rear-door 130 includes a rear-locking mechanism (not shown). The rear-locking mechanism (not shown) may toggled through the use of codes, keys, biometrics, combinations, and any further desired function. The front-door 120 may include a keypad 230 (FIG. 3) having analogue or digital options. The keypad 230 may further comprise a capacitive touchscreen technology. The capacitive touchscreen may be configured to receive and process biometric input. A display 140 (FIG. 3) is included for displaying symbolic information by emitting linearly polarized light. A controller (not shown) is in communication with the front-locking mechanism (not shown), the rear-locking mechanism (not shown), and the display 140. The display 140 is configured to receive an external signal that actuates the front-door 120 into a front-open state 122. The display 140 may be useful to convey access key information for a corresponding encryption key.

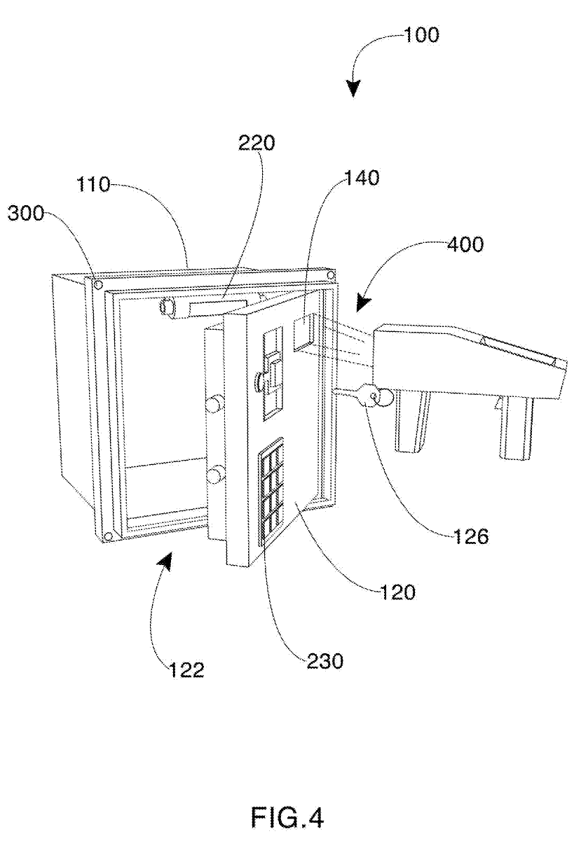

FIG. 2 shows the package receptacle 100 of FIG. 1, according to an embodiment of the present disclosure. As above, the package receptacle 100 may include a rear-door 130 disposed on an opposed end of the box 110 (FIG. 1) from the front-door 120 (FIG. 1). The rear-door 130 is configured to provide access to the substantially cubic-volume when in a rear-open state 132. The rear-door 130 includes a rear-locking mechanism (not shown). The rear-locking mechanism (not shown) is configured to be open with a rear-key. The rear-key (not shown) may take the embodiment of a combination lock, voice recognition, pattern input, an alphanumeric code, and a conventional tumbler-style key. Further means to open the rear-door 130 are considered. The controller may be configured to accept and store instructions as a program. The program may allow each component to serve an immediate purpose. The controller may also allow the addition of sensors, lights, solenoids, and all related electronical components. The display 140 (FIG. 1) is configured to receive an external signal that may be processed by the controller through custom programming. An illumination device 220 (FIG. 4), such as a light emitting diode may be adapted to work with the system. A sensor used in conjunction with the illumination device 220 may provide visual assistance when delivering and collecting parcels from the package receptacle system 100.

FIG. 3 is a perspective view of the package receptacle 100 of FIG. 1, according to an embodiment of the present disclosure. As shown, a front-door 120 configured to provide access to the substantially cubic-volume when in a front-open state 122 (FIG. 1). The front-door 120 may include a handle 210, allowing physical manipulation of the distance between the front-door 120 and the substantially cubic-volume. The front-door 120 includes a front-locking mechanism (not shown). A keypad 230 configured to process biometric input may be disposed on the system. The keypad 230 may be used in functional combination with the display 140 providing for redundant input and output functionality. The package receptacle system 100 may comprise a weatherproof material. This material may be useful for retaining temperature inside a building. The front-door 120 creates a fluid-proof seal when in a front-closed state 128. Similarly, the rear-door 130 creates a fluid-proof seal when in a rear-closed state 138. These fluid-proof seals may also be useful for retaining temperature inside a building. Further the fluid-proof seals may keep the substantially cubic-volume free from contamination by moisture and foreign particulates. The package receptacle system 100 may further include flanges 300 may be formed to any dimensions to attach the package receptacle system to a desired location. The package receptacle system may include various attachment points for mating the flanges 300 to the box 110.

FIG. 4 is another view of the package receptacle 100 of FIG. 1, according to an embodiment of the present disclosure. As shown, a front-door 120 is configured to provide access to the substantially cubic-volume when in a front-open state 122. The front-door 120 includes a front-locking mechanism (not shown). A display 140 is included on the package receptacle for displaying symbolic information by emitting linearly polarized light. A controller (not shown) is in communication with the front-locking mechanism (not shown), the rear-locking mechanism (not shown), and the display 140. The display 140 is configured to receive an external signal that actuates the front-door 120 into a front-open state 122. As illustrated the display 140 is receiving an external signal 400. This signal may initiate instructions to toggle locks, send messages, open a door, and any further conceived features. The front-locking mechanism (not shown) may be opened with a front-key 126. The front-key is useful in situations where manual override of the front-locking mechanism (not shown) is required. A keypad 230 configured to process biometric input may be disposed on the system. Biometric input to the keypad 230 may be used to toggle both the front-locking mechanism (not shown) and the rear-locking mechanism (not shown). An illumination device 220, such as a light emitting diode may be adapted to work with the system. A sensor used in conjunction with the illumination device 220 (FIG. 4) may provide visual assistance when delivering and collecting parcels from the package receptacle system 100.

As previously stated, the package receptacle system 100 allows for the integration into an existing building. The package receptacle system 100 may be sized to accommodate various wall thicknesses, building designs, and support structures. The box 110 may include flanges 300 for integration into a wall. The flanges 300 provide a secured connection between the building and the package receptacle system 100. The flanges 300 may be formed to any dimensions to attach the package receptacle system 100 to a desired location. The package receptacle system 100 may include various attachment points for mating the flanges 300 to the box 110. The package receptacle system 100 various embodiments have differing sizes, weights, materials, and features. The package receptacle system 100 may be configured to draw power from a building power supply.

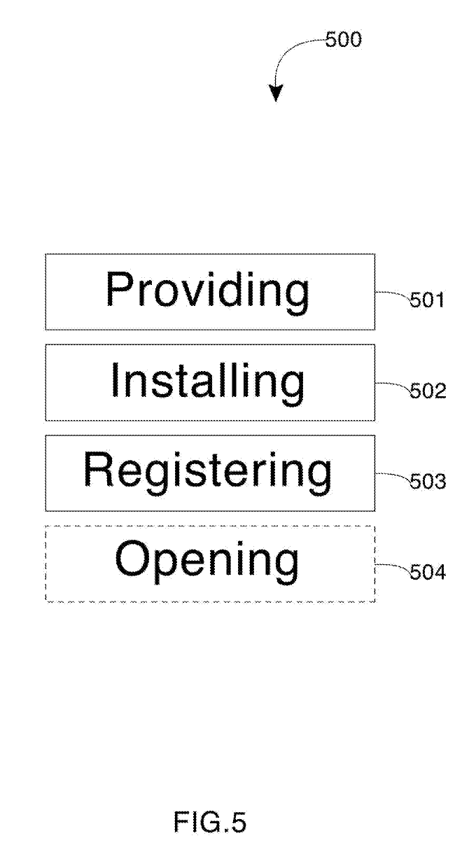

FIG. 5 is a flow diagram illustrating a method for using a package receptacle system 500 may include one or more components or features of the package receptacle 100 as described above. As illustrated, the method for using a package receptacle 500 may include the steps of: step one 501, providing a package receptacle system, the package receptacle system including a box comprising a substantially cubic-volume, a front-door, the front-door is configured to provide access to the substantially cubic-volume when in an front-open state, the front-door includes a front-locking mechanism, a rear-door, the rear-door is disposed on an opposed end of the box from the first-door, the rear-door is configured to provide access to the substantially cubic-volume when in a rear-open state, the rear-door includes a rear-locking mechanism, a display for displaying symbolic information by emitting linearly polarized light, a controller, the controller is in communication with the front-locking mechanism, the rear-locking mechanism, and the display, and, wherein the display is configured to receive an external signal that actuates the front-door into a front-open state; step two 502, installing the package receptacle into a building; step three 503, registering access functionality to the package receptacle; step four 504, opening a package receptacle with biometric input.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a package receptacle system are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A package receptacle for integration into a building, the package receptacle comprising:
a box comprising a substantially cubic-volume;
a front-door, said front-door is configured to provide access to said substantially cubic-volume when in a front-open state, said front-door includes a front-locking mechanism;
a rear-door, said rear-door is disposed on an opposed end of said box from said first-door, said rear-door is configured to provide access to said substantially cubic-volume when in a rear-open state, said rear-door includes a rear-locking mechanism;
a display for displaying symbolic information by emitting linearly polarized light;
a controller, said controller is in communication with said front-locking mechanism, said rear-locking mechanism, and said display; and,
wherein said display is configured to receive an external signal that actuates said front-door into a front-open state.

2. The package receptacle of claim 1, further comprising a handle.

3. The package receptacle of claim 1, further comprising an illumination device.

4. The package receptacle of claim 1 further comprising a keypad.

5. The package receptacle of claim 1, wherein said keypad is a capacitive touchscreen.

6. The package receptacle of claim 1, wherein said capacitive touchscreen is configured to process biometric input.

7. The package receptacle of claim 1, wherein said box includes flanges for integration into a wall.

8. The package receptacle of claim 1, wherein said front-door creates a fluid-proof seal when in a front-closed state.

9. The package receptacle of claim 1, wherein said rear-door creates a fluid-proof seal when in a rear-closed state.

10. The package receptacle of claim 1, wherein said controller is configured to accept and store instructions as a program.

11. The package receptacle of claim 1, wherein said box comprises a weatherproof material

12. The package receptacle of claim 1, wherein said rear-locking mechanism is configured to be opened with a rear-key.

13. The package receptacle of claim 1, wherein said front-locking mechanism is configured to be opened with a front-key.

14. The package receptacle of claim 1, wherein rear-locking mechanism is configured to be opened with biometric input.

15. The package receptacle of claim 1, wherein said front-locking mechanism is configured to be opened with biometric input.

16. The package receptacle of claim 1, wherein said package receptacle draws power from a building power supply.

17. A package receptacle system comprising:
a box comprising a substantially cubic-volume,
a front-door, said front-door is configured to provide access to said substantially cubic-volume when in a front-open state, said front-door includes a front-locking mechanism,
a rear-door, said rear-door is disposed on an opposed end of said box from said first-door, said rear-door is configured to provide access to said substantially cubic-volume when in a rear-open state, said rear-door includes a rear-locking mechanism,
a display for displaying symbolic information by emitting linearly polarized light,
a controller, said controller is in communication with said front-locking mechanism, said rear-locking mechanism, and said display, and,
wherein said display is configured to receive an external signal that actuates said front-door into a front-open state.
further comprising an illumination device;
further comprising a keypad;
wherein said keypad is a capacitive touchscreen;
wherein said capacitive touchscreen is configured to process biometric input;
wherein said box includes flanges for integration into a wall;
wherein said front-door creates a fluid-proof seal when in a front-closed state;
wherein rear-locking mechanism is configured to be opened with said biometric input; and
wherein said package receptacle draws power from a building power supply.

18. The package receptacle of claim 17, further comprising set of instructions; and
wherein the package receptacle is arranged as a kit.

19. A method of using a package receptacle, the method comprising the steps of:
providing a package receptacle;
installing said package receptacle to a building; and,
registering access functionality to said package receptacle.

20. The method of claim 19, further comprising the steps of
opening a package receptacle with biometric input.
